(19) United States
(12) Patent Application Publication
(10) Pub. No.: US 2013/0101762 A1
(43) Pub. Date: Apr. 25, 2013

(54) ULTRALIGHT COMPOSITE STRUCTURES

(71) Applicants: Michael Malis, Stevenson Ranch, CA (US); Gregory Peidmont, Helendale, CA (US)

(72) Inventors: Michael Malis, Stevenson Ranch, CA (US); Gregory Peidmont, Helendale, CA (US)

(73) Assignee: Lockheed Martin Corporation, Bethesda, MD (US)

(21) Appl. No.: 13/281,377

(22) Filed: Oct. 25, 2011

(51) Int. Cl. B32B 1/08; B32B 3/00; B29C 70/34; B32B 19/00; B32B 27/04; B32B 7/02; B32B 9/04; B32B 27/00

(52) U.S. Cl. 428/34.1; 428/411.1; 428/332; 428/340; 428/688; 428/292.1; 428/218; 156/184; 156/187

(57) ABSTRACT

A structure is disclosed that has a single first layer with a plurality of unidirectional fibers and a single second layer with a plurality of non-directional fibers.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND

1. Field

The present disclosure generally relates to fiber-reinforced composite (FRC) materials and, in particular, lightweight structures made from FRC materials.

2. Description of the Related Art

Components made from FRC materials often use multiple layers, or plies, wherein each layer includes fibers that are oriented in a single direction embedded in a curable polymer matrix. By orienting each of these unidirectional plies at angles with respect to each other, the designer can tailor the longitudinal and transverse properties of the multi-ply structure. As the fabrication process develops internal stresses in each ply that are aligned with the fibers of the respective ply, composite structures are commonly designed with a balanced arrangement of plies about a central plane such that the internal stresses are counterbalanced and the finished structure is not warped by these stresses.

FRC components tend to have a high strength-to-weight ratio and can provide a relatively light structure for a given load, compared to an equivalent metal structure. In some cases, however, the designs are driven by size and stiffness rather than load and even a current FRC structure is overdesigned from a strength standpoint. The number of plies of the structure can be reduced to two plies laid at an angle to each other, thereby providing adequate strength in the uncured condition to allow the sheet of FRC material to be handled during fabrication. A single uncured unidirectional ply tends to come apart when handled as the tensile strength in the transverse direction is inadequate to support the weight of the ply. This is especially true when the thickness of the single unidirectional ply approaches 0.005 inch (0.127 millimeter). It is impossible to fabricate and handle one ply unidirectional laminates with thicknesses of 0.005 inch without some kind of cross-directional reinforcement. Balanced cross plies add weight and using a layer of fabric adds weight and reduces the stiffness of the final structure.

High Altitude Long Endurance (HALE) aircraft are being contemplated for long-duration observation missions and their performance is extremely sensitive to the overall weight of the aircraft. The structures of such vehicles are very lightly loaded but must still be stiff Current designs of composite structures using multiple layers of composite tapes or fabrics produce structures that are too heavy for the planned HALE vehicles as the structures possess excess strength for the lightly loaded structures.

### SUMMARY

There is a need to provide a system and method that allows structures to be built using a single unidirectional ply of FRC.

In certain embodiments, a structure is disclosed that has a single first layer with a plurality of unidirectional fibers and a single second layer with a plurality of non-directional fibers.

In certain embodiments, a precursor suitable for forming a fiber-reinforced composite (FRC) structure is disclosed. The precursor includes a single first layer comprising a plurality of unidirectional fibers and a single second layer comprising a plurality of non-directional fibers.

In certain embodiments, a tubular structural member is disclosed that includes a single inner cylindrical layer having an outer surface. The outer layer includes a plurality of continuous carbon fibers aligned in a single direction. The structural member also includes a single outer cylindrical layer coupled to the outer surface of the inner layer. The outer layer comprises non-directional carbon fibers.

In certain embodiments, a method of forming a fiber-reinforced composite (FRC) structure is disclosed. The method includes the steps of placing a single first layer comprising unidirectional fibers and an uncured matrix material in contact with a single second layer comprising non directional fibers thereby forming a precursor, shaping the precursor into the form of the FRC structure, and curing the material of the matrix of the first layer.

### BRIEF DESCRIPTION OF THE DRAWINGS

The accompanying drawings, which are included to provide further understanding and are incorporated in and constitute a part of this specification, illustrate disclosed embodiments and together with the description serve to explain the principles of the disclosed embodiments. In the drawings:

FIG. 1 is an exemplary composite structure having a first layer comprised of continuous fibers and a matrix material according to certain aspects of the disclosure.

FIGS. 2-4 depict exemplary embodiments of composite structures according to certain aspects of the disclosure.

FIG. 5 depicts an exemplary tubular structure being formed on a mandrel according to certain aspects of this disclosure.

FIGS. 6A and 6B depict exemplary cylindrical tubular structures according to certain aspects of this disclosure.

FIGS. 7A-7E depict an exemplary series of fabrication steps for the disclosed composite structure according to certain aspects of this disclosure.

FIG. 8 depicts an exemplary truss structure according to certain aspects of this disclosure.

FIG. 9 depicts an exemplary wing structure according to certain aspects of this disclosure.

FIG. 10 depicts an exemplary composite structure according to certain aspects of this disclosure.

FIG. 11 depicts an exemplary non-woven composite layer showing fibers distributed over the layer according to certain aspects of this disclosure.

### DETAILED DESCRIPTION

The method and system disclosed herein are presented in terms of the forming a composite structure with only enough structure to meet the performance requirements of the application. The disclosure is presented in terms of structural elements suitable for construction of an aircraft suitable for long-duration operation as an unmanned platform. It will be obvious to those of ordinary skill in the art, however, that this same configuration and method can be utilized in a variety of applications wherein the structural performance requirements doe not require the multiple layers of existing composite structures. Nothing in this disclosure should be interpreted, unless specifically stated as such, to limit the application of any method or system disclosed herein to aircraft or aircraft structures.

In the following detailed description, numerous specific details are set forth to provide a full understanding of the present disclosure. It will be apparent, however, to one ordinarily skilled in the art that embodiments of the present disclosure may be practiced without some of the specific details. In other instances, well-known structures and techniques have not been shown in detail so as not to obscure the disclosure.

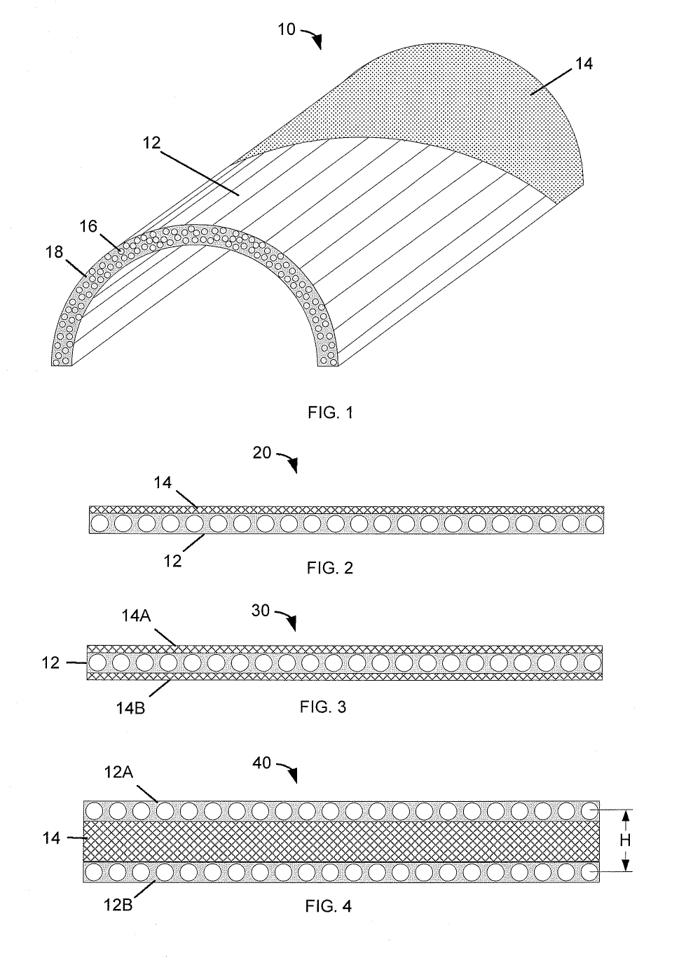

FIG. 1 is an exemplary composite structure 10 having a first layer 12 comprised of continuous fibers 16 and a matrix material 18 according to certain aspects of the disclosure. In certain embodiments, the fibers comprise carbon and the matrix is an epoxy. In certain embodiments, the fibers comprise a glass. In certain embodiments, the fibers comprise a ceramic In certain embodiments, the fibers comprise a metal. In certain embodiments, the fibers comprise an aramid. In certain embodiments, the matrix comprises a polymer such as polyester, phenolic, polyimide, and polyamide. The first layer 12, in this example, has been formed into a half tube. A second layer 14 of a non-woven fiber mat, or veil, is laid over the outside surface of the half tube of first layer 12 and is in continuous bonded contact with layer 12. The details of the structure and materials of these layers are discussed in later figures.

In certain embodiments, the layer 14 comprises continuous fibers laid down in random patterns such as shown in FIG. 11. In certain embodiments, the fibers are short, chopped fibers. In certain embodiments, the fibers may be woven into a fabric. In certain embodiments, the fibers have a coating of a sizing that holds the fibers to each other such that the layer 14 can be handled. In certain embodiments, this sizing also provides other benefits such as improved adhesion of curable materials, such as epoxy, to the fibers. In certain embodiments, the layer 14 comprises other materials that provide at least temporary adhesion between the fibers prior to being formed into a cured composite structure.

The phrase “matrix” as used here may be used as a noun, as in “the matrix,” or adjective, as in “the matrix material,” to a material that fills the spaces between the fibers of a composite structure. The matrix is provided to at least transfer loads between the fibers of the composite structure.

FIG. 1 depicts an exemplary layer 12 as having fibers with a diameter that is small in comparison to the thickness of the layer 12, thereby allowing fibers to be over each other through the thickness of the layer 12. In certain embodiments, as shown in other figures disclosed herein, layers 12 are depicted with fibers having a diameter that is approximately the same as the thickness of the layer 12. This is a function of the fiber size and the layer thickness. As carbon fibers are commonly available having diameters as small as 0.0002 inch, a layer 12 having a thickness, for example 0.005 inch, will have multiple fibers 18 through the thickness. Layers 12 can therefore have thicknesses down to 0.001 inch or less and still have multiple fibers through the thickness of the ply. Depiction of layers having a single fiber through the thickness should be considered as a convenient representation of a layer having reinforcing fibers arranged as shown in the respective figure, wherein the relative diameter of the fibers and thickness of the layer may vary by orders of magnitude from that shown.

FIGS. 2-4 depict exemplary embodiments of composite structures according to certain aspects of the disclosure. In FIG. 2, a composite structure 20 is disclosed as having a single layer 12 comprising continuous unidirectional fibers 16 that are substantially embedded in matrix 18. A single layer 14 of non-directional fibers is shown attached to one surface of layer 12. This structure is not a balanced composite structure, i.e. dos not have a symmetric arrangement of layers about a center reference plane. Current composite design guidelines commonly require a balanced arrangement of plies to minimize the internal stresses in the formed and cured composite structure. It will be discussed with reference to later figures how this non-balanced arrangement of plies can be used to form structures with adequate strength and structural integrity. In certain embodiments, the layer 14 is coupled to the layer 12 with sufficient adhesive strength that the two layers 12, 14 form a single precursor sheet prior to being formed and cured into the composite structure 20.

FRC structures may be formed from a precursor material, sometimes referred to as a “prepreg” (referring to a sheet of the precursor having a layer of fibers pre-impregnated with resin), that comprise reinforcing fibers and a matrix of a curable material. In certain embodiments, the matrix comprises a liquid resin and a thickening agent that is compounded with the fibers, after which the thickening agent causes the liquid resin to gel without curing. If the compounded sheet comprises sufficient fibers in all directions, the compounded sheet is pliable and possesses sufficient integrity to be handled. Compounded sheets or tapes having only unidirectional fibers, i.e. lacking any cross-laid fibers, may be difficult to handle as the gelled matrix material does not have sufficient strength to hold the sheet together during handling. In the embodiment of FIG. 2, the layer 14 provides sufficient cross-laid fibers to provide sufficient strength to handle uncured precursor sheets or tapes.

In certain embodiments, the layer 12 is formed from a precursor having a thickness of approximately 0.005 inch and a weight of approximately 3.7 ounces per square yard (oz/sq. yd). The final thickness and weight of the cured layer 12 depends in part on the processing pressures used during the fabrication process, as higher pressures will tend to force more of the matrix out of the sheet resulting in a thinner and lighter cure layer 12. In certain embodiments, the layer 12 precursor is thicker than 0.005 inch and heavier than 3.7 oz/sq. yd. In certain embodiments, the layer 12 precursor is approximately 0.010 inch thick and approximately 7.5 oz/sq. yd.

Within the context of this disclosure, the phrase “continuous fiber” is used to denote a single fiber bundle, or tow, that comprises one or more fibers that have a length-to-diameter aspect ratio of at least 100:1. An exemplary tow may comprise a plurality of these fibers that overlap such that the tow is longer than the individual fibers. The phrase “unidirectional” indicates that all of the fibers in the ply are substantially straight and aligned in a common direction. This direction may be aligned with an axis of the component into which the ply is incorporated, or may be aligned at an angle to this axis. A layer of continuous unidirectional fibers will have the continuous fibers passing from one end of the component to an opposite end.

FIG. 3 depicts an embodiment of a composite structure 30 wherein a single-ply 12 of continuous unidirectional fibers has a layer 14 on both sides according to certain aspects of this disclosure. In certain embodiments, the layers 14 are coupled to the layer 12 with sufficient adhesive strength that the three layers 12, 14A, 14B form a single precursor sheet prior to being formed and cured into the composite structure 30.

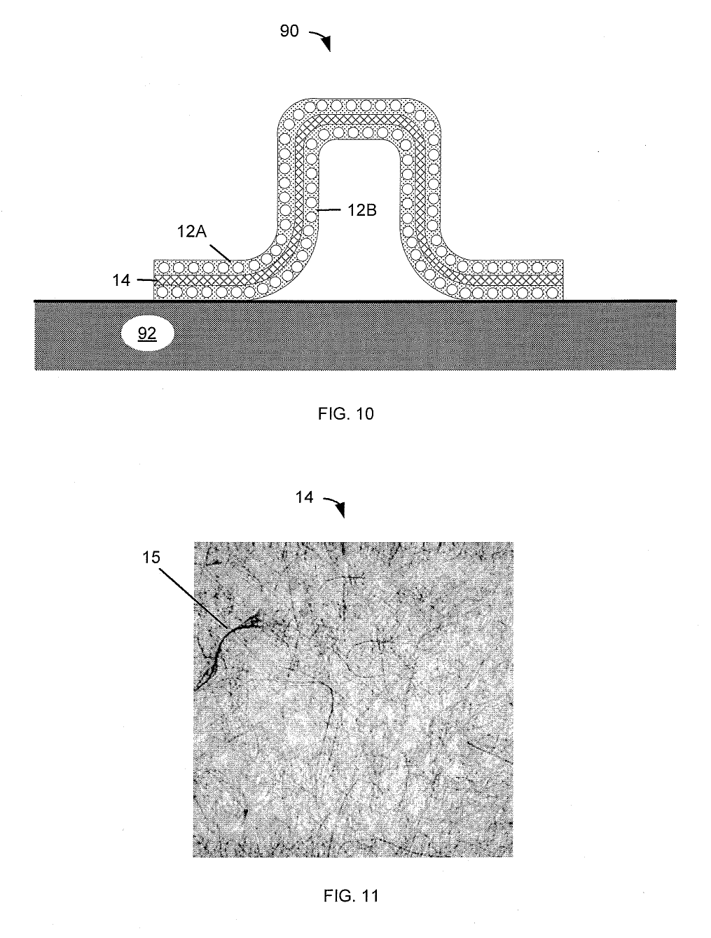

FIG. 4 depicts a composite structure 40 having a single layer 14 of non-directional fibers with layers 12A, 12B of uni-directional continuous fiber reinforcement on both sides of the structure. This balanced structure can be formed into non-symmetric components without distortion. This type of structure is discussed in greater detail with respect to FIG. 10. One advantage of this particular construction over traditional balanced-ply designs is that while a layer 14 of non-directional fibers that contributes only 10% of the total weight of the balanced structure 40 may provide 50% of the thickness, i.e. the density of the layer 14 is approximately 1/9 of the density of layers 12A, 12B, as shown in the embodiment of FIG. 4. This triples the separation H of the centers of the two surface layers 12, compared to a 2-ply structure (not shown) without a layer 14 between, thereby making effective use of the high strength of the layers 12.

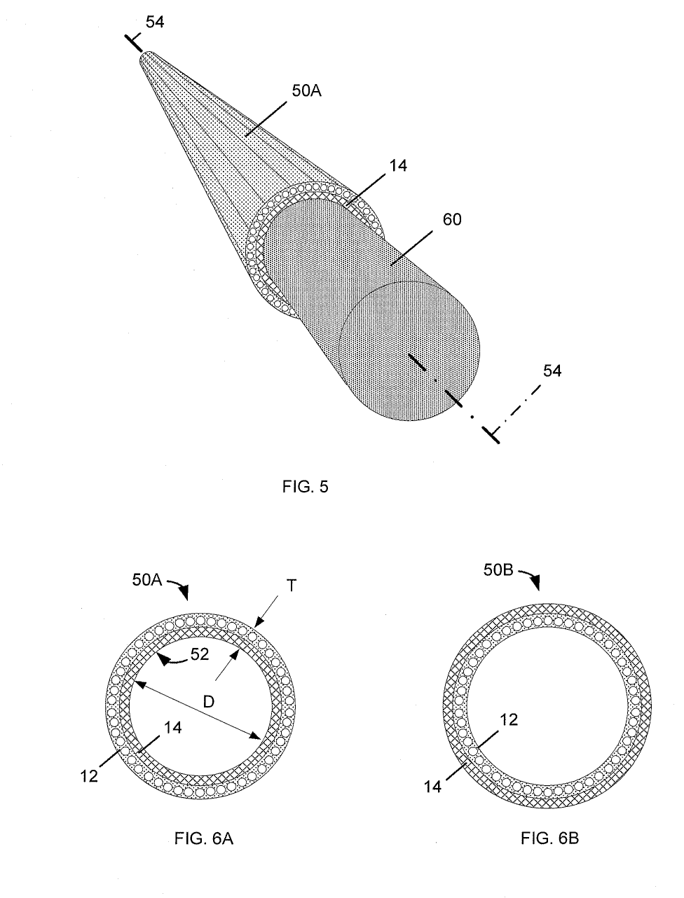

FIG. 5 depicts an exemplary tubular structure 50A being formed on a mandrel 60 according to certain aspects of this disclosure. The tubular structure 50A has the layers 12 and 14 configured with the non-woven fiber layer 14 on the inside against the surface of tool 60. When the precursor material is formed without a matrix material in layer 14, i.e. layer 14 is “dry”, and the fibers of layer 14 comprise carbon, the fibers of layer 14 provide a lubricative effect similar to graphite-based dry lubricants, thereby reducing the force required to remove the cured tubular structure 50A from the mandrel 60. In this example, the tool 16 is a linear cylinder with a center axis 54, and therefore the tubular structure 50A also has a center axis 54 when fabricated.

FIGS. 6A and 6B depict exemplary cylindrical tubular structures 50A, 50B according to certain aspects of this disclosure. FIG. 6A depicts a tubular structure having a layer 12 on the outside and a layer 14 coupled to the inner surface of layer 12. In certain embodiments, structures 50A may have a variety of diameters and thicknesses. In an exemplary embodiment, a diameter of 0.25-0.38 inch and a thickness of 0.005 inch has been found to be particularly beneficial for tubular structures of 3-5 feet in length. Surface 52 of the layer 14 would be in contact with a mandrel if formed as shown in FIG. 5.

FIG. 6B depicts the same general construction as FIG. 6A with the position of layers 12 and 14 reversed, such that the non-woven fiber layer 14 is on the outside of the tubular structure 50B. This configuration may be advantageous in providing a more durable external surface of structure 50B.

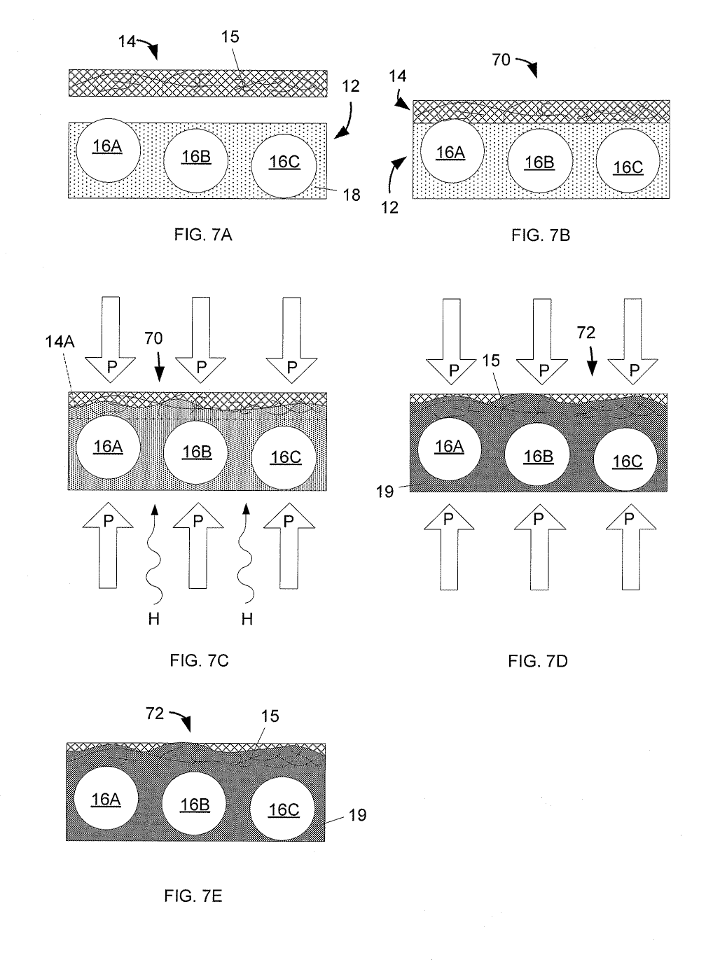

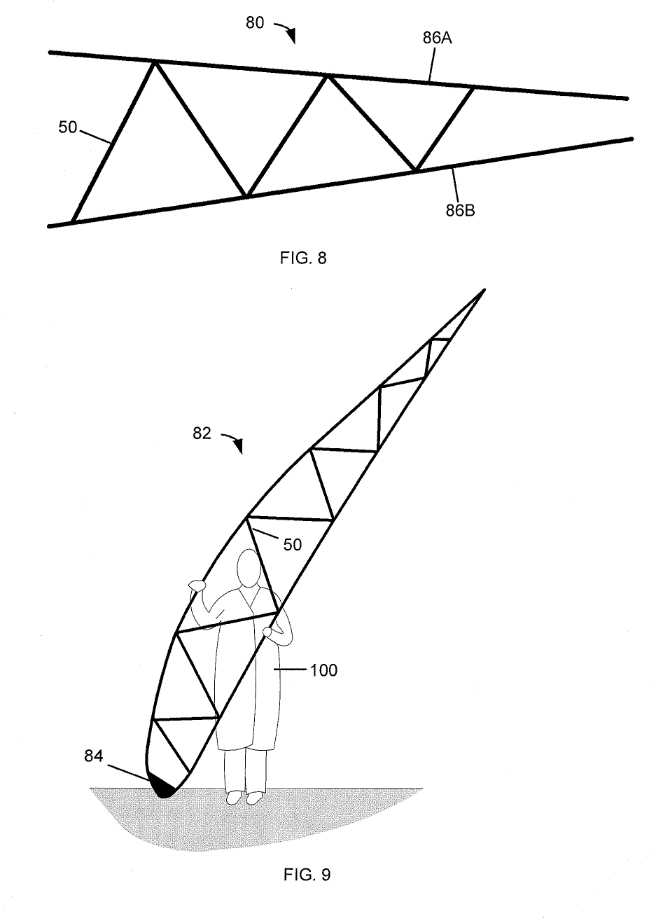

FIGS. 7A-7E depict an exemplary series of fabrication steps for the disclosed composite structure according to certain aspects of this disclosure. FIG. 7A shows the two basic components of the system, a layer 12 having, in this example, fibers 16A, 16B, and 16C embedded in a matrix material 18. It can be seen that the fiber 16B is completely embedded within the matrix material 18, while fiber 16C is exposed slightly on the lower surface and fiber 16A is partially protruding from the upper surface. The second component is a layer 14 of non-woven material comprising of fibers 15 that are adhered to each other to form a dry mat. In certain embodiments, the fibers 15 of layer 14 have a sizing (not shown) applied to the fiber 15 that improves the adhesion to a matrix material as well as holding the fibers 15 in position relative to each other during handling and processing. The fibers 15 may be continuous fibers laid down in a random, swirling pattern or may be fibers of a finite length, for example between 1 and 6 inches in length, that are laid down in random directions. More details on the construction of layer 14 represented with respect to FIG. 11.

FIG. 7B depicts the first step in processing, which is the placement of the layer 12 in contact with layer 14 to form a precursor 70. In certain embodiments, the matrix material 18 has enough exposed area on the surface in contact with layer 14 and has a consistency that provides a sufficient amount of adhesion to hold layer 14 together with layer 12. In certain embodiments, an additional temporary bonding agent, such as a sizing, may be applied to one or both of layers 12 and 14 in order to provide adhesion between the layers 12,14 during processing. It will be noted that in this particular embodiment of processing, the layer 14 does not have a matrix material between the fibers while layer 12 does have matrix material occupying at least a portion of the space between the fibers 16.

FIG. 7C depicts the second step of the forming processing, wherein heat, shown as the wavy arrows labeled with a “H”, and pressure, shown as the arrows labeled with a “P,” are applied to both sides of the precursor 70. The dashed line 14A is a reference line provided in this illustration to indicate the original position of the interface between layers 12 and 14. It can be seen that, under the influence of the applied heat H and pressure P, the matrix material 18 has been forced at least partially into the layer 14 and thereby wetting at least a portion of the fibers 15 therein.

FIG. 7D depicts the third step in the forming process, depicting a cured state of the matrix material 18, now labeled as cured matrix material 19 and the cured structure 72. It can be seen that a plurality of the fibers 15 of the former layer 14 are embedded in the material 19. At this stage in the cure process, heat H is no longer being applied while the pressure P is being maintained while the material 19 cures and the entire composite structure 72 cools.

FIG. 7E depicts the finished composite structure 72, wherein fibers 16A, 16B, 16C are substantially embedded in the cured material 19 and that at least a portion of the fibers 15 are likewise embedded in the cured material 19. Some portion of the fibers 15 may not be fully embedded in the matrix material 19 and may be held in place by the other parts of fibers 15 that are bonded to or embedded in material 19. The presence of exposed fibers 15 on the surface of structure 72 may provide some lubricity and aid in removal of the cured structure 72 from a tool (not shown in FIGS. 7A-7E).

FIG. 8 depicts an exemplary truss structure 80 according to certain aspects of this disclosure. In this example, a tapering truss 80 is shown composed of composite tubes 50 that form a diagonal printed pattern between outside tubes 86A, 86B. In certain embodiments, the tubes 50 are cylindrical in nature with fittings, not shown, at each end where they couple to other struts, for example struts 86A, 86B. In certain embodiments, a foaming adhesive (not shown in FIG. 8) is used to bond the tubes 50 to other elements of the structure 80. In certain embodiments, the structural tubes 50 may have other cross-sectional configurations, such as square or rectangular, that may facilitate the bonding to other elements and the structure integrity of the joints. In general, tubular structures 50 will have a closed perimeter in a cross section and may be of any shape that forms a closed section. In certain embodiments, structural tubes 50 of a truss structure 80 are inserted into the open end of hat section rib caps (not shown in FIG. 8) thereby forming an integral joint. Open-section components are discussed in greater detail with respect to FIG. 10.

FIG. 9 depicts an exemplary wing structure 82 according to certain aspects of this disclosure. The wing structure 82 is shown being held by a technician 100 to give a sense of scale of the structure 82, which in this example is approximately 15 feet long. The wing structure 82 has a linear lower surface and a curved upper surface connected by composite tubes 50. It can be seen that other elements, for example the nose element 84, are integrated into the structure 82.

FIG. 10 depicts an exemplary composite structure 90 according to certain aspects of this disclosure. The structure 90, in this example, is formed of a balanced composite having a center layer 14 of non-directional fibers 15 and two layers 12A, 12B bonded to each side of layer 14. This balanced arrangement of layers 12A/14/12B allows the structure 90 to be formed as a “hat” section, such as is commonly used for reinforcement of large flat panels, without the formed structure 90 twisting due to internal stresses. In this example, the hat section 90 is shown attached to a flat surface 92, for example a portion of a skin of an aircraft body. In certain embodiments, hat section rib caps are used to form integral joints with truss tubes of truss structures (not shown).

FIG. 11 depicts an exemplary non-woven composite layer 14 showing fibers 15 distributed over the layer 14 according to certain aspects of this disclosure. In this example, the fibers 15 are of finite length and approximately 6 inches long. These carbons fibers 15 are distributed in swirling, random pattern. Sheets of this type of material are commonly available and referred to as “carbon veil” or carbon mat. A carbon veil of this type will frequently have a weight of approximately 0.5 oz/sq. yd and an approximate thickness of 0.005 inch. Carbon veil is also commonly available having a weight of approximately 0.2 oz/sq. yd with an approximate thickness of 0.0021 inch and may be used according to this disclosure down to a thickness of approximately 0.001 inch.

Carbon veil is commonly provided with a sizing applied that causes the fibers to adhere to each other but the sizing does not fill the interstices of the fibers. The sizing also may provide good wetting to the resins used as matrix materials and therefore facilitate wetting of the fibers of the carbon veil by the resin during the cure process.

The concepts disclosed herein provide a system and method for fabricating ultralightweight structures comprised of fiber-reinforced composite material. The use of a lightweight layer of non-directional fibers in conjunction with a single layer of unidirectional continuous fibers provides structures that provide sufficient strength for many applications yet avoid the need for additional material beyond what is needed for the performance requirement. These structures are particularly adapted to lightweight unmanned aircraft.

The previous description is provided to enable a person of ordinary skill in the art to practice the various aspects described herein. While the foregoing has described what are considered to be the best mode and/or other examples, it is understood that various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the terms “a set” and “some” refer to one or more. Pronouns in the masculine (e.g., his) include the feminine and neuter gender (e.g., her and its) and vice versa. Headings and subheadings, if any, are used for convenience only and do not limit the invention.

It is understood that the specific order or hierarchy of steps in the processes disclosed is an illustration of exemplary approaches. Based upon design preferences, it is understood that the specific order or hierarchy of steps in the processes may be rearranged. Some of the steps may be performed simultaneously. The accompanying method claims present elements of the various steps in a sample order, and are not meant to be limited to the specific order or hierarchy presented.

Terms such as “top,” “bottom,” “front,” “rear” and the like as used in this disclosure should be understood as referring to an arbitrary frame of reference, rather than to the ordinary gravitational frame of reference. Thus, a top surface, a bottom surface, a front surface, and a rear surface may extend upwardly, downwardly, diagonally, or horizontally in a gravitational frame of reference.

A phrase such as an “aspect” does not imply that such aspect is essential to the subject technology or that such aspect applies to all configurations of the subject technology. A disclosure relating to an aspect may apply to all configurations, or one or more configurations. A phrase such as an aspect may refer to one or more aspects and vice versa. A phrase such as an “embodiment” does not imply that such embodiment is essential to the subject technology or that such embodiment applies to all configurations of the subject technology. A disclosure relating to an embodiment may apply to all embodiments, or one or more embodiments. A phrase such an embodiment may refer to one or more embodiments and vice versa.

The word “exemplary” is used herein to mean “serving as an example or illustration.” Any aspect or design described herein as “exemplary” is not necessarily to be construed as preferred or advantageous over other aspects or designs.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims No claim element is to be construed under the provisions of 35 U.S.C. §112, sixth paragraph, unless the element is expressly recited using the phrase “means for” or, in the case of a method claim, the element is recited using the phrase “step for.” Furthermore, to the extent that the term “include,” “have,” or the like is used in the description or the claims, such term is intended to be inclusive in a manner similar to the term “comprise” as “comprise” is interpreted when employed as a transitional word in a claim.

What is claimed is:

1. A structure comprising:
a single first layer comprising a plurality of unidirectional fibers; and
a single second layer comprising a plurality of non-directional fibers.

2. The structure of claim 1, wherein the first layer has a thickness of less than or equal to 0.006 inch.

3. The structure of claim 1, wherein the second layer has a thickness of less than or equal to 0.003 inch.

4. The structure of claim 1, wherein the first layer has a weight of less than or equal to 4.0 ounces per square yard.

5. The structure of claim 1, wherein the second layer has a weight of less than or equal to 0.3 ounces per square yard.

6. The structure of claim 1, wherein the fibers of the first layer comprise carbon.

7. The structure of claim 1, wherein the fibers of the first layer are continuous fibers.

8. The structure of claim 1, wherein the fibers of the second layer comprise carbon.

9. The structure of claim 1, wherein the first and second layers cooperatively form a linear tubular structure.

10. The structure of claim 9, wherein the tubular structure comprises a cylindrical tube.

11. The structure of claim 9, wherein the second layer forms an inner layer of the tubular structure and the first layer forms an outer layer.

12. The structure of claim 9, wherein the first layer forms an inner layer of the tubular structure and the second layer forms an outer layer.

13. The structure of claim 1, further comprising a matrix material that at least partially fills the spaces between the fibers of the first and second layers.

14. A precursor suitable for forming a fiber-reinforced composite (FRC) structure, the precursor comprising:
a single first layer comprising a plurality of unidirectional fibers; and
a single second layer comprising a plurality of non-directional fibers.

15. The precursor of claim 14, wherein the first layer has a thickness of less than or equal to 0.006 inch.

16. The precursor of claim 14, wherein the second layer has a thickness of less than or equal to 0.003 inch.

17. The precursor of claim 14, wherein the first layer has a weight of less than or equal to 4.0 ounces per square yard.

18. The precursor of claim 14, wherein the second layer has a weight of less than or equal to 0.3 ounces per square yard.

19. The precursor of claim 14, further comprising an uncured matrix material.

20. The precursor of claim 19, wherein the matrix material comprises an epoxy.

21. The precursor of claim 19, wherein at least some of the fibers of the first layer are embedded in the matrix material.

22. The precursor of claim 21, wherein the second layer does not comprise the matrix material.

23. The precursor of claim 14, wherein the fibers of the first layer comprise carbon.

24. The precursor of claim 14, wherein the fibers of the first layer are continuous fibers.

25. The precursor of claim 14, wherein the fibers of the second layer comprise carbon.

26. A tubular structural member comprising:
a single inner cylindrical layer having an outer surface, the inner layer comprising a plurality of continuous carbon fibers aligned in a single direction; and
a single outer cylindrical layer coupled to the outer surface of the inner layer, the outer layer comprising non-directional carbon fibers.

27. The tubular structural member of claim 26, further comprising a matrix material that at least partially fills the spaces between the fibers of the outer and inner layers.

28. The tubular structural member of claim 26, wherein the outer layer has a thickness of less than or equal to 0.003 inch.

29. The tubular structural member of claim 26, wherein the inner layer has a thickness of less than or equal to 0.006 inch.

30. The tubular structural member of claim 26, wherein the first layer has a weight of less than or equal to 4.0 ounces per square yard.

31. The tubular structural member of claim 26, wherein the second layer has a weight of less than or equal to 0.3 ounces per square yard.

32. A method of forming a fiber-reinforced composite (FRC) structure, the method comprising the steps of:
placing a single first layer comprising unidirectional fibers and an uncured matrix material in contact with a single second layer comprising non-directional fibers thereby forming a precursor;
shaping the precursor into the form of the FRC structure; and
curing the material of the matrix of the first layer.

33. The method of claim 32, where the step of shaping the precursor comprises placing the precursor proximate to a tool.

34. The method of claim 33, where the tool is a mandrel for forming a tubular structure.

35. The method of claim 34, where the step of shaping the precursor further comprises placing the second layer of the precursor in contact with a surface of the tubular mandrel.

36. The method of claim 32, where the step of shaping the precursor further comprises applying at least one of heat and pressure to the shaped precursor.

37. The method of claim 36, where the step of applying at least one of heat and pressure to the precursor comprises forcing with the pressure the uncured matrix material into the second layer thereby at least partially coating the fibers of the second layer.

38. A structure comprising:
a single first layer comprising a plurality of non-directional fibers, the first layer having a first density; and
two second layers comprising a plurality of unidirectional fibers, the second layers disposed on and coupled to opposite sides of the first layer with the unidirectional fibers of the two second layers aligned in a common direction.

39. The structure of claim 38, wherein the second layers have a second density that is less than 15% of the first density.

40. The structure of claim 39, wherein the weight per square foot of the first layer is less than or equal to 10% of the total weight per square foot of the combined first and second layers.
